(19) United States
(12) Patent Application Publication
(10) Pub. No.: US 2009/0148637 A1
(43) Pub. Date: Jun. 11, 2009

(54) FABRICATION OF FIRE RETARDANT MATERIALS WITH NANOADDITIVES

(75) Inventors: Chun Zhang, Tallahassee, FL (US); Ben Wang, Tallahassee, FL (US); Zhiyong Liang, Tallahassee, FL (US)

Correspondence Address: SUTHERLAND ASBILL & BRENNAN LLP, 999 PEACHTREE STREET, N.E., ATLANTA, GA, 30309, US

(73) Assignee: FLORIDA STATE UNIVERSITY RESEARCH FOUNDATION, Tallahassee, FL (US)

(21) Appl. No.: 12/258,043

(22) Filed: Oct. 24, 2008

Related U.S. Application Data
(60) Provisional application No. 60/982,959, filed on Oct. 26, 2007.

(51) Int. Cl. B32B 1/02; B32B 27/06; B32B 5/02; B05D 7/22; B29C 45/02; B32B 5/16

(52) U.S. Cl. 428/34.5; 428/34.1; 428/35.7; 427/230; 264/328.1; 427/236; 977/773; 977/752; 977/902

(57) ABSTRACT

Apparatuses with improved flammability properties and methods for altering the flammability properties of the apparatuses are provided. In certain embodiments, the apparatus comprises an occupant structure having an exterior portion and an interior portion defining an occupant space. The interior portion is formed, at least in part, of a composite material and a first nanoadditive fixed on a surface of the composite material proximate the occupant space. In one embodiment, the nanoadditive may comprise a continuous network of nanoscale fibers.

### CROSS-REFERENCE TO RELATED APPLICATIONS

Priority is claimed to U.S. Provisional Application Ser. No. 60/982,959, filed Oct. 26, 2007, which is incorporated herein by reference.

### BACKGROUND OF INVENTION

This invention relates generally to fire retardants, and more particularly relates to fire retardants comprising nanoadditives.

Composites, which may include materials such as fiber and/or organic resin, are attractive materials for construction due to their strength, low weight, and weather resistance. However, these materials may have undesirable characteristics such as surface flammability, smoke generation, and generation of toxic products when exposed to an open flame or high radiant heat. As a result, use of these composites in construction of buildings and vehicles may affect their fire safety because heavy smoke hinders escape of occupants and toxic gases may act as a main cause of occupant death in a fire.

Known polymer matrix fiber-reinforced composites and reinforced plastics therefore may be designed to improve fire resistance by including fire retardant resins and additive compounds in the composite materials. A large number of these conventional fire retardants are bromine based. When burning, these bromine containing compounds may produce toxic fumes, such as hydrobromic acid, which may cause pulmonary edema. Other, less toxic additives, such as aluminum trihydroxide (ATH) and magnesium hydroxide, may be less efficient and may require very high loading levels. In addition, the additive-to-resin ratios may be so high that the desirable physical properties of the resin are degraded so that the mechanical characteristics of the engineered composite product may be dramatically diminished.

Phosphorus compounds also may be used as fire retardants. When used as an additive, the phosphorus compounds may migrate to the surface of a matrix material, diminishing the fire retardancy of the matrix material. More recently, phosphorus compounds have been incorporated into the backbone of resins. The advantage of being covalently linked into the backbone of resins may be elimination or reduction of migration of phosphorus compounds so that fewer phosphorus compounds are required to increase the their fire retardant effectiveness. However, the phosphorus based resins may still produce smoke and acidic fumes. Furthermore, the phosphorus flame retardants do not prevent some types of epoxy having a low tolerance to temperature (e.g., glass transition temperature (Tg) of 40° C. less or so) from melting or decomposing when exposed to an open flame.

Intumescent coatings also may be used as fire retardants. Such coatings may incorporate an organic material that may form char when exposed to heat. A properly formed char may serve as an effective thermal insulation layer, protecting the underlying material from the fire. Basic intumescent ingredients may be contained within additional components to provide greater coherence and adhesion to the substrate, offer better mechanical properties and weathering resistance, and remain an effective insulating layer in the presence of a fire. When intumescent coatings are used, the durability of a coating (e.g., in terms of long-term adhesion and weather resistance) may be a factor in its viability for infrastructure usage. Unfortunately, both inorganic intumescent (e.g., alkali silicates) coatings and organic intumescent (e.g., phosphorous-nitrogen bond containing) coatings may have limitations. For example, intumescent coatings may react with carbon dioxide (CO₂) or absorb moisture in the atmosphere, causing the coating to gradually lose its intumescence, become brittle, and lose its adhesion.

It would therefore be desirable to provide fire retardant materials and methods to overcome these limitations. In addition, it would be useful to provide fire retardant compositions that maintain or enhance the mechanical properties of the polymer composites. Better fire retardant composite materials are needed.

### SUMMARY OF THE INVENTION

Apparatuses with improved flammability properties and methods for altering the flammability properties of the apparatuses are provided. In certain embodiments, the apparatus includes an occupant structure having an exterior portion and an interior portion defining an occupant space. The interior portion is formed, at least in part, of a composite material and a first nanoadditive fixed on a surface of the composite material proximate the occupant space.

In one embodiment, the composite material may include polymeric composite materials, reinforced polymeric materials, carbon fiber composite materials, glass fiber composite materials, or combinations thereof.

The first nanoadditive may be a continuous network of nanoscale particles. For instance, the continuous network of nanoscale particles may comprise a continuous network of nanoscale fibers. In certain embodiments, the first nanoadditive may be a nanoscale particle selected from nanoscale fibers, nanoscale silicates, silicate/nanoscale fiber nanocomposites, silicate/polymer nanocomposites, polyhedral oligomeric silsesquioxanes, and combinations thereof. In one embodiment, the first additive may be multi-wall nanotubes.

In another embodiment, the interior portion further includes a second nanoadditive fixed in or on the composite material distal the first nanoadditive. For example, the first nanoadditive and the second nanoadditive may each be a continuous network of nanoscale fibers.

In one embodiment, the occupant structure may be part of an aircraft, a watercraft, a wheeled vehicle, or the like.

In another embodiment, the first nanoadditive may be fixed on the surface of the composite material substantially surrounding the occupant space.

In another aspect, the interior portion of the occupant space may include a structural material and a first nanoadditive fixed on a surface of the structural material proximate the occupant space, wherein the first nanoadditive may be a nanoscale particle selected from nanoseale fibers, nanoscale silicates, silicate/nanoscale fiber nanocomposites, silicate/polymer nanocomposites, polyhedral oligomeric silsesquioxanes, and combinations thereof. In some embodiments, the structural material may include a polymeric material, carbon fiber material, or a glass fiber material.

In a further aspect, a method is provided for altering the flammability properties of a composite material used in an occupant structure. This may include providing a composite material and applying a first nanoadditive to a surface of the composite material at a position to be proximate an occupant space in the occupant structure.

In some embodiments, the steps of providing the composite material and the step of applying the first nanoadditive occur substantially simultaneously. In one embodiment, the continuous network of nanoscale particles may include a continuous network of nanoscale fibers. In certain embodiments, the composite material may include a resin and a fiber material and the first nanoadditive includes a continuous network of nanoscale fibers, and the steps of providing the composite material and applying the nanoadditive include vacuum assisted resin transfer molding of the resin through the continuous network of nanoscale fibers and the fiber material.

In another embodiment, the step of applying the first nanoadditive includes spraying a solution of nanoscale particles onto the composite material.

### BRIEF DESCRIPTION OF THE DRAWINGS

FIGS. 1A-B illustrate an embodiment of a composite which may be produced by coating carbon or glass weaves with nanotubes. The process is illustrated schematically in FIG. 1A. The product produced thereby is shown in FIG. 1B.

FIG. 2 illustrates an embodiment of an apparatus with improved flammability properties.

FIG. 3 illustrates a schematic of one embodiment of a polyhedral oligomeric silsesquioxane (POSS)/glass fiber composite with buckypaper.

FIG. 4 is a graph of heat release data from cone calorimeter testing of embodiments of POSS/glass fiber composites with and without buckypaper (BP).

FIG. 5 is a graph showing the smoke production rate (SPR) and the total smoke release rate (TSR) of embodiments of POSS/glass fiber composites with and without buckypaper.

FIG. 6 is a graph showing the carbon monoxide (CO) and carbon dioxide (CO₂) production of embodiments of POSS/glass fiber composites with and without buckypaper.

FIGS. 7A-B are graphs which show comparisons of heat release rate curves for embodiments of Resin/IM7, Resin/IM7/SWNT-buckypaper (BP), and Resin/IM7/MWNT-BP composites.

FIGS. 8A-B are graphs which show smoke production parameters of combustion of embodiments of Resin/IM7, Resin/IM7/SWNT-BP, and Resin/IM7/MWNT-BP composites.

FIGS. 9A-B are graphs which show comparisons of CO production during combustion of embodiments of Resin/IM7, Resin/IM7/SWNT-BP, and Resin/IM7/MWNT-BP composites.

FIG. 10 is a graph which shows the thermal gravimetric analysis results of embodiments of epoxy, modified bismaleimide resin (BMI), SWNT buckypaper, and MWNT buckypaper in air.

### DETAILED DESCRIPTION OF THE INVENTION

Methods and nanoscale additives (also called “nanoadditives”) have been developed for reducing one or more flammability properties of materials, such as polymer or fiber structural materials and composite materials. Due to the low density, small pore size, low gas permeability, high chemical resistance and high thermal stability of certain embodiments of these nanoadditives, they may act as a protective layer on an occupant structure to reduce fire spread, toxic smoke, and gas generation during combustion. Unlike other flame-retardant approaches for polymers that may tend to unfavorably alter the mechanical properties of the polymers, the present materials with nanoadditives may have improved mechanical properties along with the improved flammability properties. These nanoadditives may be used as reinforcement and flame retardant constituents to improve thermal stability while retaining the thermal mechanical properties of the structural material or composite materials. Furthermore, due to the high electrical conductivity of some embodiments of the nanoadditives, materials treated with these nanoadditives may have improved lightning strike protection and enhanced EMI shielding properties. Moreover, the inert nature of some embodiments of the nanoadditives protects them from the atmosphere.

As used herein, “flame retardant” in reference to the nanoadditives refers to the characteristic of reducing one or more flammability property of another material, such as the structural materials or the composite materials. As used herein, the term “flammability property” refers to the flammability, the smoke generation, the toxic product generation, combinations thereof, or other similarly undesirable properties of the materials when exposed to fire or radiant heat. These flammability properties may be or may correlate to measurements of time to ignition, heat release rate (HRR), total heat released, peak heat release rate, maximum average rate of heat emission, fire growth rate, total smoke released, smoke production rate, carbon dioxide yield, carbon monoxide yield, and/or mass loss during combustion.

“Maximum average rate of heat emission” (MAHRE) is defined as the total heat released from t=0 to time t divided by time t. The MAHRE may be considered an ignition modified rate of heat emission parameter, which may be useful to rank materials in terms of ability to measure fire spread to other objects. Thus, a lower MAHRE value may indicate a reduction in fire spread hazard.

“Fire growth rate” (FIGRA) is determined by dividing the peak HRR by the time to peak HRR. The FIGRA represents the rate of fire growth for a material once exposed to heat. A higher FIGRA may suggest faster flame spread and possible ignition of nearby objects.

As used herein, the terms “comprise,” “comprising,” “include,” and “including” are intended to be open, non-limiting terms, unless the contrary is expressly indicated.

### The Apparatus and the Occupant Structure

As used herein, “apparatus” refers to a building, frame, compartment, wall, craft, vehicle, or the like, or portion thereof which includes an “occupant structure” (e.g., walls, cockpit, passenger compartment, etc.) that defines a room, area, or chamber (i.e., an “occupant space”) adapted for entry and habitation by a human or other animal. In one embodiment, as shown in FIG. 2, the present fire retardant composite 16 having a nanoadditive 18 substantially covers a substantial portion of the interior portion 14 of the occupant structure 12 of the apparatus 10. For example, the composite material may cover more than 50%, such as from 80% to 100% of the walls bounding an occupant space.

In certain embodiments, the nanoadditives may be applied to a composite material which is a part for a craft or vehicle such as an aircraft, land-based vehicle, or marine vessel.

### The Structural Material and the Composite Material

The nanoadditives described herein may be used with or incorporated into a variety of structural materials and composite materials to reduce one or more flammability properties of the structural materials and the composite materials. Representative examples of suitable structural materials may include polymers (e.g., ethylene-vinyl acetate copolymer), resins (e.g., diglycidyl ether of bisphenol F, modified bismaleimide resin (BMI), or polyhedral oligomeric silsesquioxane (POSS) resin), carbon fibers, or glass fibers. In some embodiments, the nanoadditive may be dispersed in a homogeneous mixture or heterogeneous mixture with a structural material such as a polymer. For example, the heterogeneous mixture with a structural material may be in a gradient structure. In one embodiment, the nanoadditives may be dispersed onto or into a woven or nonwoven fiberous structural material (e.g., carbon or glass weaves) or other structural material substrate.

In some embodiments, a structural material may be combined with one or more other materials in various forms and composite materials. In certain embodiments, the composite materials may include fibrous materials dispersed into, woven into, or saturated by another material, such as a plastic, polymer, or a resin. For instance, a composite material could include carbon fibers, glass fibers, fiberglass, aramid fibers or combinations thereof dispersed in a polymeric material. In other embodiments, the composite material may additionally include adhesives, metals, or any other suitable materials to make the composite material suitable for its intended use.

In one embodiment, the nanoadditives are included in one or more layers in a multi-layer composite material. For instance, the nanoadditives may be in the form of a film included in a multi-layer composite structure. In another embodiment, the nanoadditives may be dispersed onto or into a composite material.

### Nanoadditives

Silicates

In one embodiment, the nanoscale additives may be layered silicates. For instance, the layered silicates may be a nanoscale dispersion of the clay sheets in a composite material with large aspect ratios. In other embodiments, the nanoadditives may be clay/polymer nanocomposites or ammonium salt treated clay. Without being bound by a particular theory, the addition of nanoadditives including clays may substantially retard flames by encouraging the formation of a strong char, which limits the passage of degradation products out of a composite material that may lead to continued fueling of a fire.

Nanoscale Fibers and Nanoscale Fiber Films

In certain embodiments, the nanoadditives may include nanoscale fibers and nanoscale fiber films, such as carbon nanoscale fiber films (also referred to as “buckypaper”). Without being bound by a particular theory, carbon nanotubes are believed to be useful as a flame retardant nanoadditive because of their highly elongated shape and a balance between the effect of thermal conductivity and shielding performance of external radiant flux (and heat feedback from the flame) at certain amounts in a structural material.

In other embodiments, buckypapers may be used as a nanoadditive fire-shielding layer on the surface of a structural material or composite laminates. In some embodiments, the formed tube networks in the buckypapers may be kept in the composite fabrication operation and transferred into the final solid nanocomposites, providing a nanotube reinforcement structure for the final nanocomposites. Without being bound by a particular theory, a flame retardant mechanism of polymer nanocomposites includes charred layer formation as a protective barrier on the material surface during combustion. Thus, buckypaper, which has a small pore size and low gas permeability, may act as a physical barrier on the surface of a composite to slow the escape or spread of flammable molecules.

In other embodiments, a synergistic effect between clay and multiple-walled nanotubes (MWNTs) in silicate/nanoscale fiber nanocomposites may provide improved flame retardancy in ethylene-vinyl acetate copolymer (EVA) by the filler combination of clay and MWNTs from the peak heat release rate (PHRR) point of view. Without being bound by a particular theory, the nanoadditives are believed to play an active role in the formation of the compact char with closed surfaces, and the MWNTs, with their long aspect ratio, may add strength and offer resistance to mechanical cracks.

As used herein, the term “nanoscale fibers” refers to a thin, greatly elongated solid material, typically having a cross-section or diameter of less than 500 nm. In a preferred embodiment, the nanoscale fibers comprise or consist of carbon nanotubes, including both single walled nanotubes (SWNTs) and MWNTs. As used herein, the term “film” refers to thin, preformed sheets of well-controlled and dispersed porous networks of SWNT, MWNT materials, carbon nanofibers (CNFs), or mixtures thereof. SWNTs typically have small diameters (˜1-5 nm) and large aspect ratios, while MWNTs typically have large diameters (˜5-200 nm) and small aspect ratios. CNFs are filamentous fibers resembling whiskers of multiple graphite sheets or MWNTs.

As used herein, the terms “carbon nanotube” and the shorthand “nanotube” refer to carbon fullerene, a synthetic graphite, which typically has a molecular weight between about 840 and greater than 10 million. Carbon nanotubes are commercially available, for example, from Carbon Nanotechnologies, Inc. (Houston, Tex. USA), Sigma-Aldrich, or Applied Sciences, Inc., or may be made using techniques known in the art.

Carbon nanotubes and carbon nanofibers have high surface areas (e.g., about 1,300 m²/g), which results in high conductivity and high multiple internal reflection. Films of carbon nanotubes and nanofibers, or buckypapers, are thin, preformed sheets of well-controlled and dispersed porous networks of SWNTs, MWNTs, CNFs, or mixtures thereof. The carbon nanotube and nanofiber film materials are flexible, light weight, and have mechanical, conductivity, and corrosion resistance properties desirable for numerous applications. With these fibers and films, nanoscale materials, and consequently their properties, may be transferred into macroscale materials for ease of handling.

The nanoscale fiber films used in the composites may be made by essentially any suitable process known in the art. In some embodiments, the nanoscale film materials may be made by a method that includes the steps of (1) suspending SWNTs, MWNTs, and/or CNF in a non-solvent, and then (2) removing the non-solvent to form the film material. The step of removing the non-solvent may include a filtration process, vaporizing the non-solvent or solvent, or a combination thereof. For example, the films may be made by dispersing nanotubes in water or other non-solvent liquid to form suspensions and then filtering the suspensions to form the film materials. In one embodiment, the nanoscale fibers are dispersed in a low viscosity medium such as water or a low viscosity organic liquid to make a suspension and then the suspension may be filtered to form dense conducting networks in thin films of SWNT, MWNT, CNF or their mixtures. Other suitable methods for producing nanoscale film materials are disclosed U.S. Published Patent Application No. 2006/0207931 A1, entitled, “Method for Continuous Fabrication of Carbon Nanotube Networks or Membrane Materials”.

Additional examples of suitable methods for producing nanoscale film materials are described in S. Wang, Z. Liang, B. Wang, C. Zhang, “High-Strength and Multifunctional Macroscopic Fabric of Single-Walled Carbon Nanotubes,” Advanced Materials, 19, 1257-61 (2007); Z. Wang, Z. Liang, B. Wang, C. Zhang and L. Kramer, “Processing and Property Investigation of Single-Walled Carbon Nanotube (SWNT) Buckypaper/Epoxy Resin Matrix Nanocomposites,” Composite, Part A: Applied Science and Manufacturing, Vol. 35 (10), 1119-233 (2004); and S. Wang, Z. Liang, Giang Pham, Young-Bin Park, Ben Wang, Chuck Zbang, Leslie Kramer and Percy Funchess, “Controlled Nanostructure and High Loading of Single-Walled Carbon Nanotubes Reinforced Polycarbonate Composite,” Nanotechnology, Vol. 18, 095708 (2007).

In various embodiments, good dispersion and alignment may be realized in buckypapers materials, which may assist developing high nanoparticle content (i.e., greater than 20 wt. %) and high performance composites materials.

The nanotubes optionally may be opened or chopped, for example, as described in U.S. Patent Application Publication No. 2006/0017191 A1.

The nanotubes and CNFs may be randomly dispersed, or may be aligned, in the produced films. In one embodiment, the fabrication method further includes aligning the nanotubes in the nanoscale film. For example, this may be done using in situ filtration of the suspensions in high strength magnetic fields, as described for example, in U.S. Patent Application Publication No. 2005/0239948 to Haik et al.

In various embodiments, the film s may have an average thickness from about 5 to about 100 microns thick with a basis weight (i.e., area density) as low as about 0.07 oz./ft² or about 21 g/m².

The nanotube and nanofibers optionally may be chemically modified or coated with other materials to provide additional functions for the films produced. For example, in some embodiments, the carbon nanotubes and CNFs may be coated with metallic materials to enhance their conductivity.

Polyhedral Oligomeric Silsesquinoxanes

In yet another embodiment, polyhedral oligomeric silsesquioxanes (POSS) may be used as fire retardant nanoadditives. POSS is an organic-inorganic hybrid material that enables enhancement of properties in polymers by providing nanostructural materials. POSS includes of organomineral bonding (i.e., Si—O—Si and Si—R). With an oxygen to silicon ratio equaling 1.5 (SiO_{1.5}), POSS presents an intermediate structure between that of a silicon (R₂SiO) and that of silica (SiO₂), which may explain its oxidation resistance and reaction to fire. The organic group (R) allow for compatibility of POSS with organic resins. POSS may also contain functional Si—Y groups that will be able to react with the monomers and form integral parts of the macromolecule. The fire retardant effectiveness (e.g., the improvement of ignition time and the reduction of PHRR) of POSS in polyurethane coatings may be demonstrated by cone calorimeter data.

In some embodiments, POSS/clay nanocomposites (e.g., nanocomposites formed from POSS-treated clay), which may show a higher glass transition temperature (T_{g}) and temperature difference (T_{d}) than that of a nanoadditive comprised of an ammonium salt treated clay, may also be used as nanoadditives.

Methods of Applying and/or Incorporating Nanoadditives

Due to their small pore size, low permeability, chemical resistance and high thermal stability, nanoadditives may be used to design and fabricate polymeric composites with improved fire safety by applying nanoadditives onto the surface of a substrate to act as a fire retardant shielding to protect the substrate from fire hazards. In one embodiment, the nanotubes may be applied by a spraying method or applied as a nanoadditive film (e.g., buckypaper). The substrate may be a polymeric substrate.

Nanoadditive films may be applied onto the surface of a material, such as a composite material by vacuum assisted resin transfer molding (VARTM), resin transfer molding (RTM), prepreg/autoclave, and hand lay-up methods, for example. Such processes facilitate the composites fabrication using traditional molding methods. In one embodiment, nanoscale fiber films may be placed adjacent to each side of a fiber fabric and then placed in a mold, and then a resin may be distributed through the layers using VARTM to form a flame retardant composite.

Alternatively, a spray process may be used to disperse thin layers of nanoadditives onto a surface of a woven fabric structural material (e.g., a prepreg composite material or a layup composite material) or composite material. For example, carbon or glass weaves may be coated with nanotubes using a mist spray gun, or other apparatuses or methods known in the art.

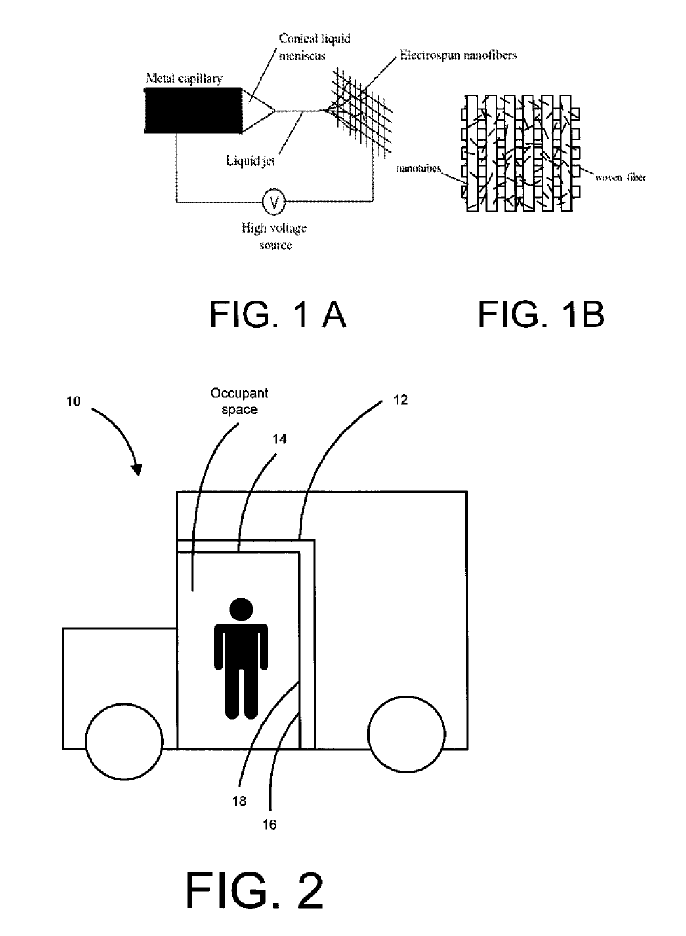

FIGS. 1A-B illustrate an embodiment of a composite which may be produced by coating carbon or glass weaves with nanotubes by a spray process. First, the nanotubes may be dispersed in a liquid (e.g., a solvent or water) at a desired concentration. The amount of nanotubes may be calculated based on the weight ratio to fiber reinforcement. The mixture may be sonicated in a bath ultrasonicator (e.g., 40 kHz) for better dispersion. A mist spray gun may be used to evenly coat the nanotubes onto the surface of woven fibers. Thereafter, the liquid may be allowed to evaporate prior to VARTM processing.

A representative example of a suitable solvent may include acetone.

The compositions and methods described above will be further understood with reference to the following non-limiting examples.

### EXAMPLES

### Example 1

### Fabrication of Composites with Buckypapers

Purified SWNTs under the brand name BuckyPearls™, from Carbon Nanotechnologies Inc. (CNI) (Houston, Tex.) were used in this example. The CNI technical data sheet and report stated that the individual tubes were about 0.8-1.2 nm in diameter and 100-1000 nm long and had a residual metal content of 3-12 wt %. The bulk density of the BuckyPearls™ was 0.4 g/cm³. The SWNTs were used without further purification. MWNTs used in this example were obtained from Sigma-Aldrich with purity >90% and 10-20 nm in diameter and 0.5-500 μm long. Carbon nanofibers used in this example were obtained from Applied Sciences, Inc. and had diameters of 100-150 nm and were 30-100 μm long. The POSS (PM 1287, Hybrid Plastics) was used in this example as a structural material in glass fiber reinforced composites.

### Material Fabrication

Buckypapers were prepared by grinding BuckyPears™ with a small amount of water using a mortar and pestle. After sonicating with a Sonicator 3000 (Misonix Inc.) a thick black paste was formed. A surfactant and more deionized water were added into the paste and the paste was sonicated for 30-200 minutes, depending on suspension concentration. The multi-step sonication produced a stable ink-like suspension, which was found to remain stable for several weeks. The final concentration of the suspension was 10-200 mg SWNT/L. The suspension was sent through a filter with the aid of pressure to fabricate the buckypaper. Following filtration, the buckypapers were thoroughly washed with deionized water to remove the dispersion surfactant. The buckypapers were carefully peeled from the filter and dried overnight at room temperature and then dried in a vacuum oven.

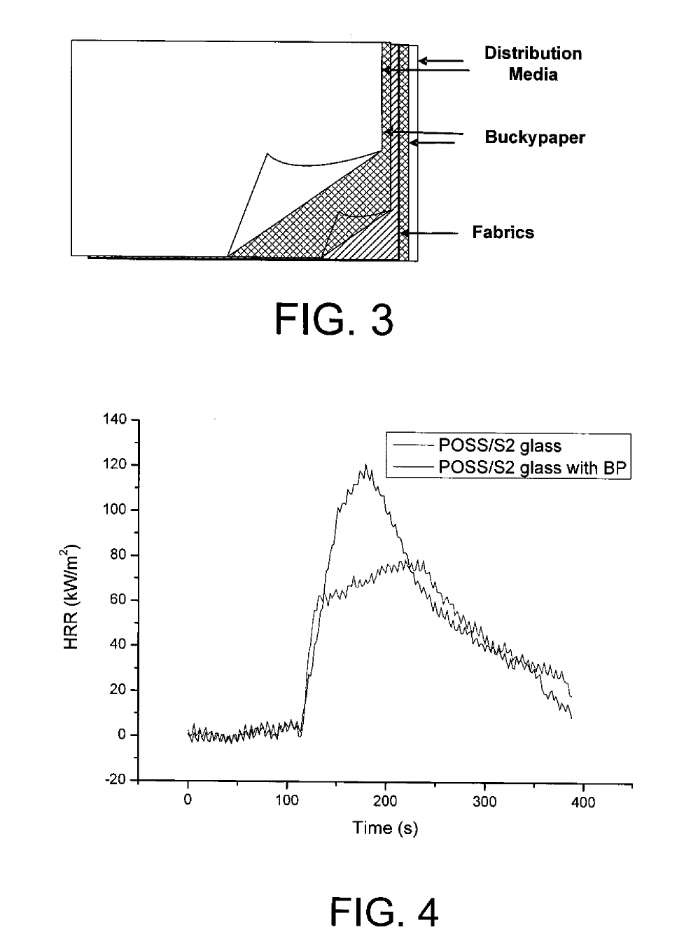

VARTM was used to fabricate the composites with buckypaper skins. As shown in FIG. 3, buckypapers were placed on the both sides of glass fiber fabrics and placed on a mold. After the lay-up operation was completed, a peel ply, resin distribution media and vacuum bag film were placed on the top of fiber mats. The vacuum film bag was then sealed around the perimeter of the mold and a vacuum pump was used to draw a vacuum within the mold cavity. The mold was then filled, during which time the POSS resin was suctioned into the mold under atmospheric pressure. During the VARTM process, the distribution media provided a high permeability region in the mold cavity, which allowed the POSS resin to quickly flow across the surface of the laminate to wet the laminate. Finally, the composite was cured at room temperature for 24 hours and post-cured in the oven for another 2 hours at 100C.

### Measurement and Testing Data

Nitrogen adsorption isotherms were collected at 77K (Micromeritics Tristar 3000) and pore size analysis was performed by the Barret-Joyner-Halenda (BJH) method.

TABLE 1
Pore size of different buckypapers

| Buckypaper | Avg. pore size (nm) |
|---|---|
| SWNT | 4.46 |

SWNT-MWNT

| | |
|---|---|
| 3:1 | 5.52 |
| 1:1 | 7.12 |
| 1:3 | 8.63 |

SWNT-CNF

| | |
|---|---|
| 3:1 | 5.68 |
| 1:1 | 6.00 |
| 1:3 | 6.66 |

Table 1 lists the pore size of buckypaper made by SWNT, MWNT and CNF with different ratios. The average pore size of each of the buckypapers was less than 10 nm. Thus, the permeability was low and the buckypapers may act as protective layer to reduce one or more flammability property of the POSS resin/glass fiber composites.

The ASTM E1354 standard test method for heat and visible smoke release rates for the POSS resin/glass fiber composites was conducted using an oxygen consumption calorimeter. Cone calorimeter evaluation of the POSS resin/glass fiber composite with and without buckypaper skin provided data with respect to peak and average heat release rates and smoke production rates. FIG. 4 illustrates the heat release rate (HRR), total heat release (THR), smoke-extinction area (SEA), and total carbon monoxide (CO) yield behavior for POSS resin/glass fiber composites with and without buckypapers obtained from cone calorimeter test.

TABLE 2
Summary of cone calorimeter data

| | | | Time | | | | | |
|---|---|---|---|---|---|---|---|---|
| | | | to | | | Total | Total | Sample |
| | Time to | Peak | Peak | | Average | smoke | CO | thickness/ |
| | ignition | HRR | HRR | THR | SEA | Release | yield | weight |
| Sample | (sec) | (kW/m²) | (sec) | (MJ/m²) | (m²/kg) | (m²/m²) | (kg/kg) | (mm/g) |
| POSS/ | 117 | 124 | 184 | 15.5 | 84.8 | 23.7 | 0.11 | 3.9/59.51 |
| Glass fiber | | | | | | | | |
| POSS/ | 107 | 79 | 220 | 15.5 | 37 | 11.0 | 0.03 | 3.8/60.03 |
| Glass | | | | | | | | |
| fiber/BP | | | | | | | | |
| Improvement | −10 | 36% | Delay | 0 | 56% | 54.5% | 0.08 | N/A |
| | | | 36 | | | | | |

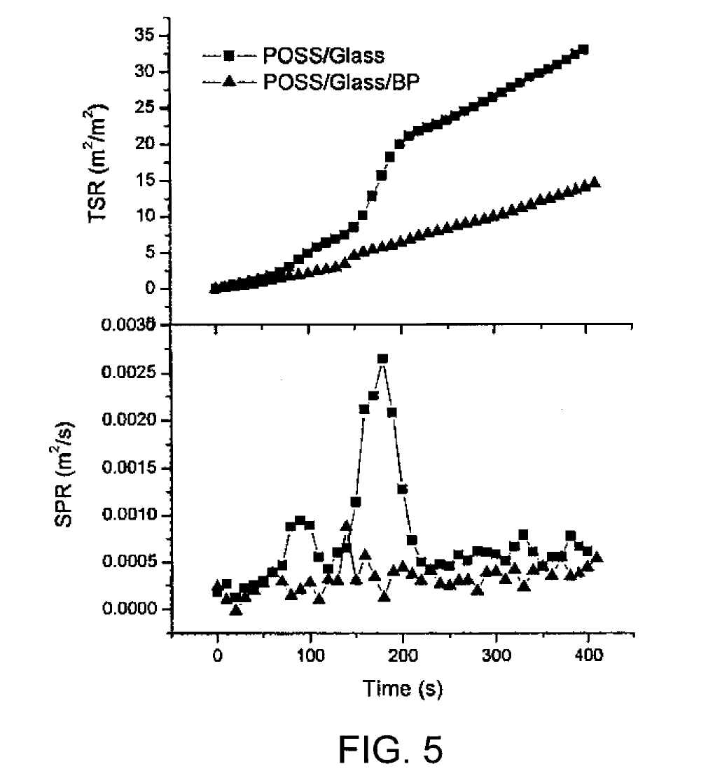

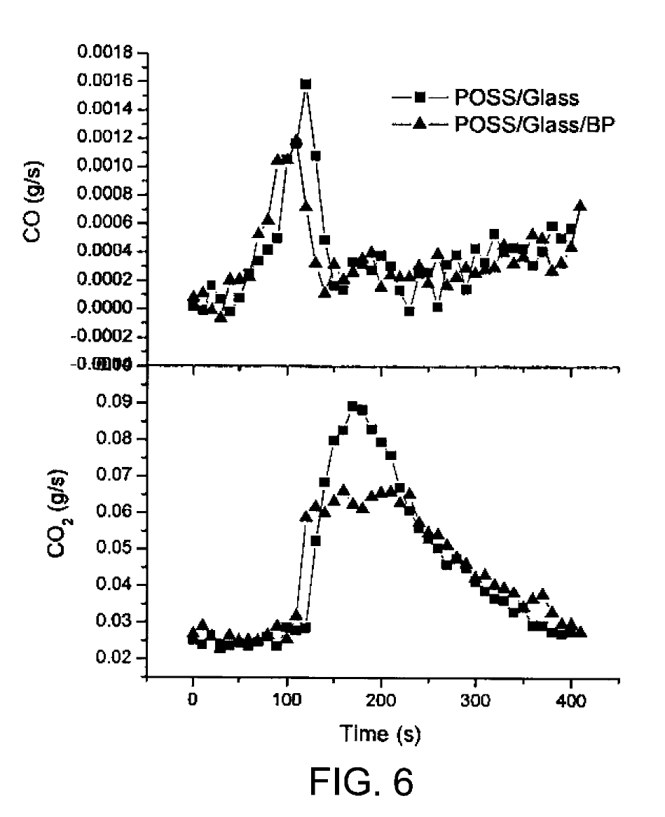

The inclusion of buckypaper on the composite surface decreased the peak of HRR by 36%. Buckypapers also reduced the smoke production more than 50%. FIG. 5 shows that the smoke production rate (SPR) and the total smoke release rate (TSR) of the POSS resin/glass fiber composites with buckypaper were lower than the POSS resin/glass fiber composites without buckypaper. FIG. 6 shows the decrease in CO and carbon dioxide (CO₂) production for the POSS resin/glass fiber composites with buckypaper as compared to the POSS resin/glass fiber composites without buckypaper.

These results demonstrate that buckypaper shielding may improve fire, smoke, and toxicity performance of the POSS resin/glass fiber composites. For instance, without being bound by a particular theory, smoke production may be ascribed to the dehydrogenation effect, which leads to aromatic volatiles in the flame. Thus, lower smoke production indicates that the buckypaper may have acted as a physical barrier in filtering soot.

### Example 2

### Fabrication of Composites with Buckypapers

Additional composites were produced with buckypapers. High pressure carbon monoxide (HiPco) SWNTs were purchased from Carbon Nanotechnologies, Inc. MWNTs were obtained from Thomas Swan, Inc. The epoxy resin used was diglycidyl ether of bisphenol F (DGEBF (Epon 862) Shell Chemicals). The epoxy was cured with diethylene toluene diamine (DETDA (EPI-CURE W), Shell Chemicals). Modified bismaleimide resin (BMI) (5250-4 RTM resins, from Cytec, Inc.) was used as the structural material. IM7 carbon fiber fabrics (style 4178, Texile Products, Inc) were used as reinforcement.

Buckypapers were prepared by filtering a carbon nanotube suspension through a membrane with the aid of a pressure pump. Following filtration, the buckypapers were washed with water to remove the surfactant. After air drying, buckypapers about 20 μm thick were peeled from the membrane.

Epoxy/IM7 composites and BMI/IM7 composites with and without buckypaper skins were fabricated by processing the composites using hand lay-up followed by vacuum bagging and curing at approximately 350° F. For control composites, eight layers of IM7 carbon fiber fabrics were incorporated in the composite laminates. For buckypaper skin composites, the buckypaper was placed at both the top and bottom of IM7 carbon fiber laminates on a mold.

Combustion tests were performed on approximately 102×102×2.6 mm samples with a cone calorimeter, using the standardized cone calorimeter testing procedure (ASTM E-1354-02d). The total weight of each sample was approximately 36 g (24 g carbon fiber, 12 g resin, and 0.15 g per layer of buckypaper). The thickness of the samples ranged from approximately one-eighth of an inch to one-fourth of an inch. Tests were performed at 50 kW/m2 external heat flux, and three tests for each sample were conducted. Thermogravimetric analyses were performed using a Q 50 thermogravimetric analyzer from TA Instruments with a heating ramp of 10° C./min from 50° C. to 800° C. under air atmosphere.

### Results

Table 3 reports the main parameters for each material obtained from cone calorimeter measurements. The parameters include Time to Ignition (TTI), Heat Release Rate (HRR), Total Heat Released (THR), Maximum Average Rate of Heat Emission (MAHRE), Fire Growth Rate (FIGRA), Total Smoke Released (TSR), CO and CO₂ yields, mass loss during combustion.

TABLE 3
Main parameters from cone calorimeter measurements.

| | | | Time | | | | | | |
|---|---|---|---|---|---|---|---|---|---|
| | | | to | | | Total | | | Total |
| | | Peak | Peak | | | CO | | | mass |
| | TTI | HRR | HRR | THR | TSR | yield | MAHRE | | loss |
| Sample | (s) | (kW/m²) | (s) | (MJ/m²) | (m²/m²) | (kg/kg) | (kw/m2) | FIGRA | (g) |
| Epoxy/ | 46 | 568 | 84 | 23.2 | 1123.7 | 0.1 | 179 | 6.77 | 10.6 |
| IM7 | | | | | | | | | |
| Epoxy/ | 50 | 526 | 95 | 24.5 | 1180.1 | 0.08 | 151.8 | 5.64 | 10.8 |
| IM7/ | | | | | | | | | |
| SWNT- | | | | | | | | | |
| BP | | | | | | | | | |
| Epoxy/ | 64 | 258 | 94 | 13.2 | 526.1 | 0.08 | 82 | 2.75 | 6.2 |
| IM7/ | | | | | | | | | |
| MWNT- | | | | | | | | | |
| BP | | | | | | | | | |
| BMI/ | 52 | 661 | 79 | 20.8 | 957.9 | 0.1 | 177 | 8.37 | 9.1 |
| IM7 | | | | | | | | | |
| BMI/ | 61 | 248 | 92 | 14.2 | 480.8 | 0.08 | 81 | 2.69 | 6.7 |
| IM7/ | | | | | | | | | |
| SWNT- | | | | | | | | | |
| BP | | | | | | | | | |
| BMI/ | 67 | 232 | 96 | 12.6 | 462.5 | 0.05 | 72 | 2.44 | 5.9 |
| IM7/ | | | | | | | | | |
| MWNT- | | | | | | | | | |
| BP | | | | | | | | | |

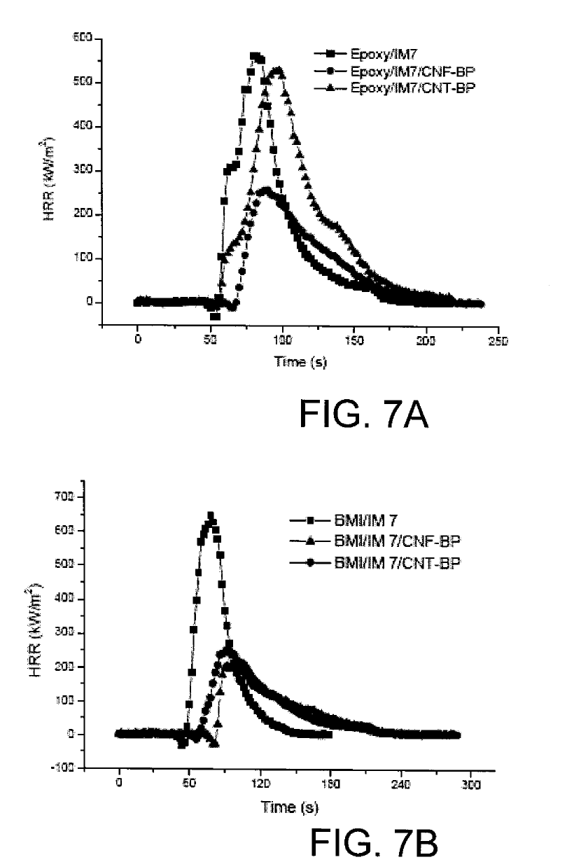

FIGS. 7A-B show a comparison of heat release rate curves for Resin/IM-7, Resin/IM-7/SWNT-BP and Resin/IM-7/MWNT-BP. In the case of epoxy-based composites, the heat release rates of the Epoxy/IM-7/SWNT-BP composite was about the same as that of the Epoxy/IM-7 composite, whereas a large reduction was observed for Epoxy/IM-7/MWNT-BP. The peak heat release rate of the Epoxy/IM-7/MWNT-BP composite was about 45% of that of the Epoxy/IM-7 composite. In the case of BMI-based composites, the peak heat release rates of the BMI/IM-7/SWNT-BP and BMI/IM-7/MWNT-BP composites showed more than 60% reduction compared to the BMI/IM-7 composite.

The time to ignition for a Resin/IM-7/BP composite appears later with respect to the Resin/IM-7 composites. Less resin inside the top buckypaper layer due to its carbon rich area might be responsible for the delayed ignition time. The time-to-peak HRR was 10 seconds longer for Resin/IM-7/BP composites compared to Resin/IM-7 composites.

The value of total heat release (THR), the integral of heat release rate curves over the duration of the experiment, of the Epoxy/IM-7/MWNT-BP composite was 60% of that of the Epoxy/IM-7 composite, whereas the THR value of the Epoxy/IM-7/SWNT-BP was close to that of the Epoxy/IM-7 composite. For the BMI-based composites, both BMI/IM-7/MWNT-BP and BMI/IM-7/SWNT-BP composites showed much lower THR values than that of the BMI/IM-7 composites. The reduction of THR values indicates that the presence of buckypaper may restrict fire development or even extinguish a fire.

A reduction in mass loss during the combustion was found in the Epoxy/IM-7/MWNT-BP, BMI/IM-7/MWNT-BP and BMI/IM-7/SWNT-BP composites. The values of total mass loss may provide evidence that the presence of buckypaper may reduce the mass loss during the combustion, which is directly relative to the THR values. These results show that the buckypaper layer may have acted as a mass transport barrier to slow release of combustible compounds, which reduced the fuel to support a fire.

MAHRE (maximum average rate of heat emission) and FIGRA (fire growth rate) were the indices introduced to rank the hazard of developing fires. The MAHRE and FIGRA data in Table 3 shows that the presence of buckypaper on the surface of Resin/IM-7 composites may have reduced the values of MAHRE and FIGRA, in particular for the Epoxy/IM-7/MWNT-BP, BMI/IM-7/MWNT-BP and BMI/IM-7/SWNT-BP composites. The reduction of MAHRE or FIGRA was greater than 55% or 60%, respectively.

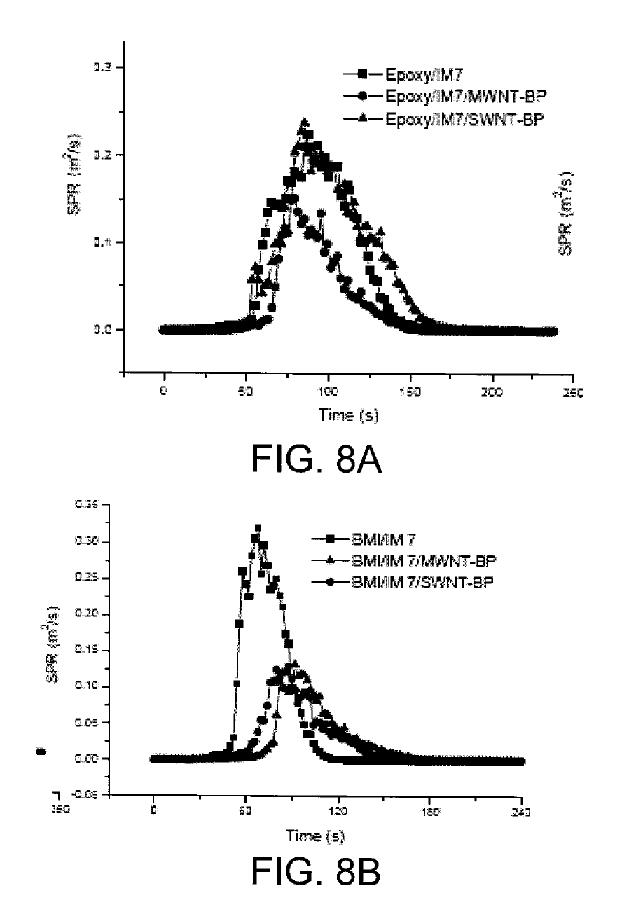

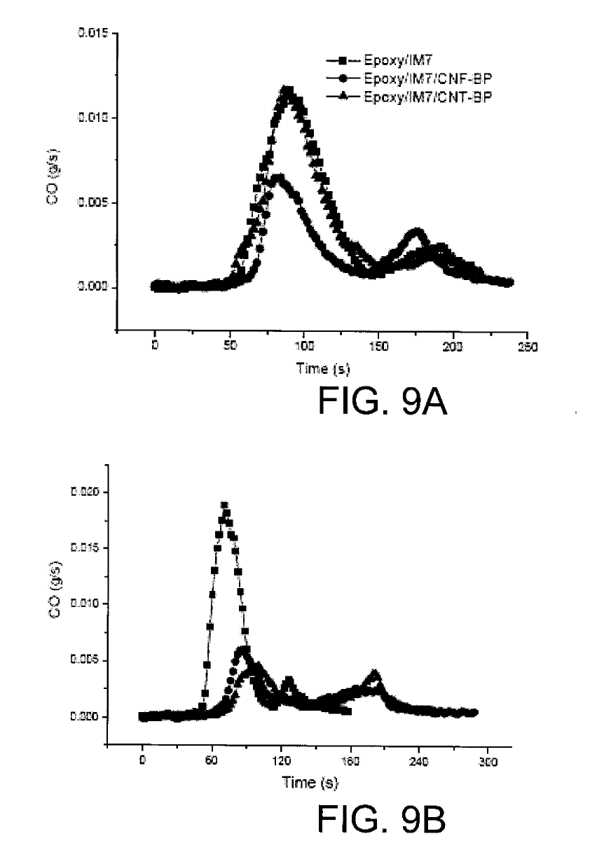

FIGS. 8A-B and Table 3 report smoke production parameters. Except for the Epoxy/IM7/SWNT-BP composite, the values of the smoke production rate (SPR) and total smoke released (TSR) of the Resin/IM7/Buckypaper composites were reduced by more than 50% compared to the Resin/IM7 composites. The smoke production may be ascribed to the thermal decomposition of resins, which leads to aromatic volatiles in the flame. The lower smoke production indicates that the buckypaper may have acted as a physical barrier in filtering the soot. FIGS. 9A-B shows the CO production decreased in CO yield due to the buckypaper skin.

Visual observation of the composites show that the IM7 carbon fiber fabrics from the Resin/IM-7 composites were totally exposed after combustion. However, the residues from Resin/IM-7/MWNT-BP composites were covered by buckypaper. The residues from the Epoxy/IM-7/SWNT-BP and the BMI/IM-7/SWNT-BP composites are different. The SWNT buckypaper on the surface of Epoxy/IM-7 composites were burned out with the red iron catalyst residue left on the surface. However, SWNT buckypaper partially remained on the surface of the BMI/IM-7/SWNT-BP composite after combustion. This observation may explain the different effect of SWNT buckypaper on the fire behaviors between the Epoxy/IM-7/SWNT-BP and BMI/IM-7/SWNT-BP composites. The thermo-oxidation stability of buckypaper indicates that the buckypaper may act as an effective fire shield on the composite surface if the buckypaper can survive during the flame combustion.

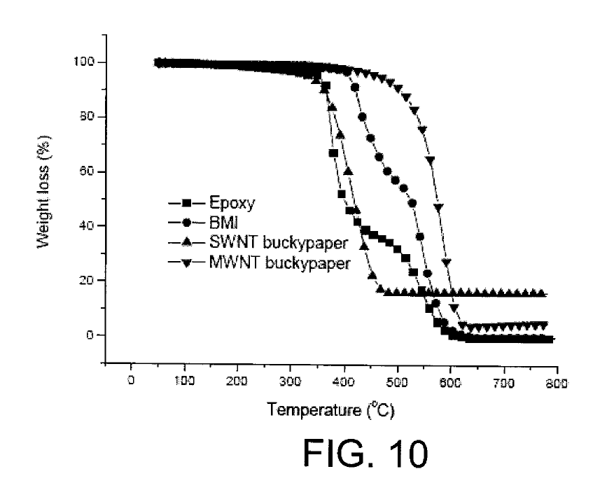

Thermo-oxidation stability of the resin and buckypaper was evaluated by thermal gravimetric analysis (TGA). FIG. 10 shows the TGA curves in air. At the cone calorimeter test conditions, the surface temperature at 50 kW/m² external heat fluxes may reach around 500° C. The onset degradation point of SWNT buckypaper and epoxy are approximately the same temperature, or about 400° C. During the cone calorimeter tests, SWNT-buckypapers were burned together with epoxy due to their similar low thermo-oxidation stability, which is believed to be why SWNT buckypapers appear to have acted as a flame retardant in the Epoxy/IM-7/SWNT-BP composites. In the case of BMI/IM-7/SWNT-BP composite, the initial degradation onset temperature of BMI was about 450° C., and the second weight loss step, which is related to the degradation of carbonaceous char formed during the first weight loss step, started at about 520° C. The carbonaceous char from BMI decomposition remained on the surface of SWNT buckypaper and reduced the thermo-oxidation of SWNT buckypaper. The surviving SWNT buckypaper may reduce the release of flammable volatiles from the under skin, due to the buckypaper's dense structure and low gas permeability. During the flame combustion, the SWNT buckypaper was also consumed. MWNT-buckypaper survived after fire tests due to its high thermo-oxidation degradation onset temperature (about 550° C.) and may have acted as the fire shield to delay and reduce the flammable specimens release (e.g., the exposure of the flammable components of the composite to the fire). This result may explain why the presence of MWNT buckypaper on the composites resulted in the improved flammability properties of the composites.

These results show that the enhanced flame retardancy of epoxy or BMI carbon fiber composites was achieved by incorporating buckypaper on the surface of the composite material. The thermo-oxidation stability of buckypaper was a factor in improving flame retardant properties of composites. At the cone calorimeter test conditions, the MWNT-based buckypaper, due to its high thermo-oxidation, survived and may have acted as an effective fire shield to reduce heat, smoke and toxic gases generated during fire combustion. SWNT-based buckypaper was burned out after combustion in the Epoxy/IM7/SWNT-BP composite and did not affect the flammability of the composite. In the case of BMI/IM7/SWNT-BP composite, due to the synergistic effect between BMI and SWNT buckypaper, the buckypaper partially survived, which indicates the SWNT buckypaper may act as fire shield to retard the fire development during the combustion.

Publications cited herein are incorporated by reference. Modifications and variations of the methods and devices described herein will be obvious to those skilled in the art from the foregoing detailed description. Such modifications and variations are intended to come within the scope of the appended claims.

We claim:

1. An apparatus with improved flammability properties comprising:
an occupant structure having an exterior portion and an interior portion defining an occupant space, wherein the interior portion is formed, at least in part, of a composite material and a first nanoadditive fixed on a surface of the composite material proximate the occupant space.

2. The occupant structure of claim 1, wherein the first nanoadditive comprises a continuous network of nanoscale particles.

3. The occupant structure of claim 2, wherein the composite material comprises a resin and a fiber material, and wherein the continuous network of nanoscale particles comprises a continuous network of nanoscale fibers.

4. The occupant structure of claim 1, wherein the first nanoadditive comprises a nanoscale particle selected from the group consisting of nanoscale fibers, nanoscale silicates, silicate/nanoscale fiber nanocomposites, silicate/polymer nanocomposites, polyhedral oligomeric silsesquioxanes, and combinations thereof.

5. The occupant structure of claim 1, wherein the first nanoadditive comprises multi-walled nanotubes.

6. The occupant structure of claim 1, wherein the interior portion further comprises a second nanoadditive fixed in or on the composite material distal the first nanoadditive.

7. The occupant structure of claim 6, wherein the first nanoadditive and the second nanoadditive each comprise a continuous network of nanoscale fibers.

8. The occupant structure of claim 1, wherein the composite material comprises a polymeric composite material, a reinforced polymeric material, a carbon fiber composite material, a glass fiber composite material, or a combination thereof.

9. The occupant structure of claim 1, wherein the occupant structure is part of an aircraft, a watercraft, or a wheeled vehicle.

10. The occupant structure of claim 1, wherein the first nanoadditive fixed on the surface of the composite material substantially surrounds the occupant space.

11. An apparatus with improved flammability properties comprising:
occupant structure having an exterior portion and an interior portion defining an occupant space, wherein the interior portion is formed, at least in part, of a structural material and a first nanoadditive fixed on a surface of the structural material proximate the occupant space, wherein the first nanoadditive comprises a nanoscale particle selected from the group consisting of nanoscale fibers, nanoscale silicates, silicate/nanoscale fiber nanocomposites, silicate/polymer nanocomposites, polyhedral oligomeric silsesquioxanes, and combinations thereof.

12. The occupant structure of claim 11, wherein the structural material comprises a polymeric material, carbon fiber material, or a glass fiber material.

13. The occupant structure of claim 11, wherein the first nanoadditive comprises a continuous network of nanoscale fibers.

14. The occupant structure of claim 11, wherein the interior portion further comprises a second nanoadditive fixed in or on the composite material distal the first nanoadditive.

15. A method for altering the flammability properties of a composite material used in an occupant structure comprising:
providing a composite material; and
applying a first nanoadditive to a surface of the composite material at a position to be proximate an occupant space in the occupant structure.

16. The method of claim 15, wherein the steps of providing the composite material and the step of applying the first nanoadditive occur substantially simultaneously.

17. The method of claim 16, wherein the composite material comprises a resin and a fiber material and the first nanoadditive comprises a continuous network of nanoscale fibers, and wherein the steps of providing the composite material and applying the nanoadditive comprise vacuum assisted resin transfer molding of the resin through the continuous network of nanoscale fibers and the fiber material.

18. The method of claim 15, wherein the step of applying the first nanoadditive comprises spraying a solution of nanoscale particles onto the composite material.

19. The method of claim 15, wherein the composite material comprises a polymeric composite material, a reinforced polymeric material, a carbon fiber composite material, a glass fiber composite material, or a combination thereof.

20. The method of claim 15, wherein the first nanoadditive comprises a continuous network of nanoscale particles.

21. The method of claim 15, wherein the first nanoadditive comprises a nanoscale particle selected from the group consisting of nanoscale fibers, nanoscale silicates, silicate/nanoscale fiber nanocomposites, a silicate/polymer nanocomposites, polyhedral oligomeric silsesquioxanes, and combinations thereof.

22. The method of claim 15, wherein the first nanoadditive comprises multi-walled nanotubes.

23. The method of claim 15, further comprising applying a second nanoadditive into or on the composite material distal the first nanoadditive.

24. The method of claim 23, wherein the first nanoadditive and the second nanoadditive each comprise a continuous network of nanoscale fibers.

25. The method of claim 15, wherein the occupant space is part of an aircraft, a watercraft, or a wheeled vehicle.
